(19) United States
(12) Patent Application Publication
(10) Pub. No.: US 2005/0005041 A1
(43) Pub. Date: Jan. 6, 2005

(54) Storage medium adapting interface device

(75) Inventors: Chung I. Lin, Hsinchu Hsien (TW); Shang Che Sun, Jubei City (TW); Chia Te Liao, Taipei (TW)

Correspondence Address: BACON & THOMAS, PLLC, 625 SLATERS LANE, FOURTH FLOOR, ALEXANDRIA, VA, 22314, US

(73) Assignees: C-One Technology Corporation, Hsin-Chu City (TW); Pretec Electronics Corporation, Fremont, CA (US)

(21) Appl. No.: 10/788,381

(22) Filed: Mar. 1, 2004

(30) Foreign Application Priority Data
Mar. 7, 2003 (TW) 92203513

(51) Int. Cl. G06F 13/10

(52) U.S. Cl. 710/62

(57) ABSTRACT

The present invention provides a storage medium adapting interface device, comprising a connecting interface and a wireless module for connecting to an application device and an electronic device having a storage device respectively, and a buffer to temporarily store the data from the connecting interface and the wireless module. If the application device asks for writing data into the memory card, the data will be written into the buffer temporarily, and a file is created and opened in the storage device, so that the data can be written into the file via the wireless module. If the application device asks for reading data from the memory card, the file in the storage device is opened, and then the data is written into the buffer via the wireless module. Finally, the data in the buffer is transferred to the application device via the connecting interface.

### BACKGROUND OF THE INVENTION

1. Field of the Invention

The present invention relates to a storage device and, more particularly, to a storage medium adapting interface device which is capable of using an electronic storage device to simulate a memory card.

2. Description of Related Art

With the advance of electronic technology, many electronic devices are miniaturized for providing convenience. For example, a memory card can be used on the digital camera, PDA or Palm to extend the storage capacity of the portable electronic devices. This memory card typically made of the flash memory is used as a storage media and has its storage limit in storage fucntion accordingly. For example, the capacity of a Compact Flash card (CF card) is limited to 1 GB. The memory card has to be removed if more memory is required, resulting in an inconvenience is use. Therefore, it is desired to improve the use of above conventional memory card so as to mitigate and/or obviate the aforementioned problem.

### SUMMARY OF THE INVENTION

The object of the invention is to provide a storage medium adapting interface device for portable electronic devices to simulate the access to a memory card.

In accordance with one aspect of the present invention, the storage medium adapting interface device comprises: a connecting interface adapted to an application device and receive a command from the application device; a wireless module adapted to an electronic device having a storage device in a wireless manner; a buffer to temporarily store data from the connecting interface and the wireless module; a protocol command switch used to convert the commands between the connecting interface and the wireless module; and a microprocessor to interpret the command sent from the application device via the connecting interface. When the microprocessor receives a writing command from the application device to write data to a memory card, the data is temporarily written into the buffer for storage, and the protocol command switch converts format of the writing command of the connecting interface into format of the command of the wireless module and creates and opens a file in the storage device of the electronic device, so that the data can be written into the file via the wireless connection. When the microprocessor receives a reading command from the application device to read data from the memory card, the protocol command switch converts format of the reading command of the connecting interface into format of the command of the wireless module, and opens the file in the storage device, so that the data can be read from the file and written to the buffer via the wireless connection for being further transferred to the application device via the connecting interface.

In accordance with another aspect of the present invention, the storage medium adapting interface device comprises: a first connecting interface adapted to an application device and receives a command from the application device; a second connecting interface adapted to connect to an electronic device having a storage device; a buffer to temporarily store the data from the first and the second connecting interfaces; a protocol command switch to convert commands between the first and the second connecting interfaces; and a microprocessor to interpret the command sent from the application device via the first connecting interface. When the microprocessor receives a writing command from the application device to write data to a memory card, the data is written into the buffer to be temporarily stored, and the protocol command switch converts format of the writing command of the first connecting interface into format of the command of the second connecting interface, and creates and opens a file in the storage device of the electronic device, so that the data can be written into the file via the second connecting interface. When the microprocessor receives a reading command from the application device to read data from a memory card, the protocol command switch converts format of the reading command of the first connecting interface into format of the command of the second connecting interface, and opens a file in the storage device, so that the data can be read from the file and written to the buffer via the second connecting interface for being further transferred to the application device via the first connecting interface.

Other objects, advantages, and novel features of the invention will become more apparent from the following detailed description when taken in conjunction with the accompanying drawings.

### BRIEF DESCRIPTION OF THE DRAWINGS

FIG. 1 is the schematic diagram of the storage medium adapting interface device in accordance with the first embodiment of the present invention;

FIG. 2 is the block diagram of the storage medium adapting interface device of the present invention;

FIG. 3 is the flow chart of creating a wireless connection between the storage medium adapting interface device and the electronic device;

FIG. 4 is the control flow chart of the storage medium adapting interface device;

FIG. 5 is the flow chart of the application program of the electronic device; and

FIG. 6 is the schematic diagram of the storage medium adapting interface device in accordance with the second embodiment of the present invention.

### DETAILED DESCRIPTION OF THE PREFERRED EMBODIMENT

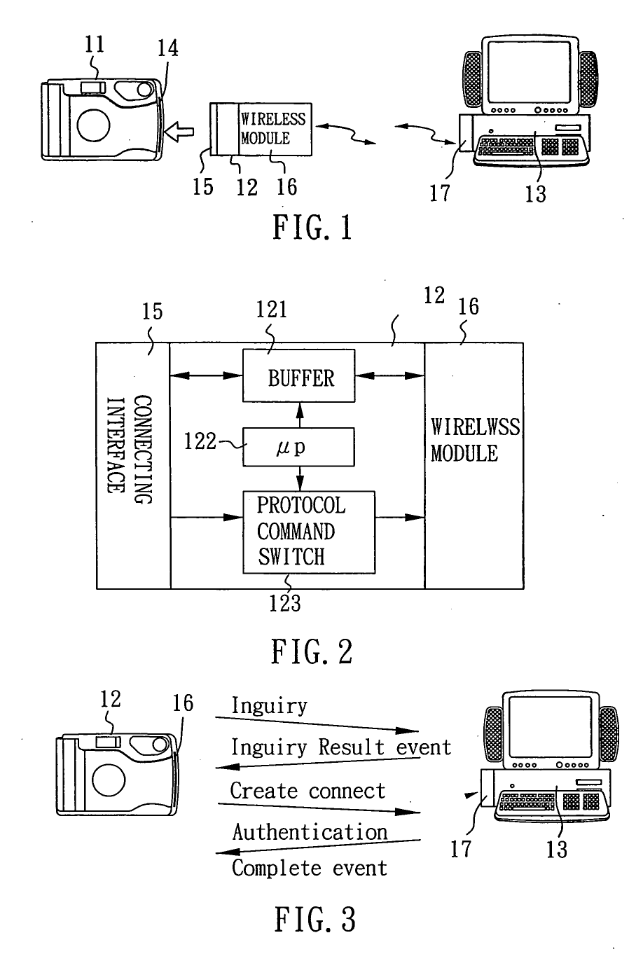

With reference to FIG. 1, there is a first preferred embodiment of the storage medium adapting interface device in accordance with the present invention, wherein an application device 11, such as a digital camera, has an interface slot 14 for being inserted with the storage medium adapting interface device 12 via the connecting interface 15. The storage medium adapting interface device 12 includes a wireless module 16 for connecting to a wireless module 17 of an electronic device 13 in a wireless manner. In this embodiment, the electronic device 13 is preferred to be a PC, a notebook, a PDA or a portable storage disk. The connecting interface 15 is preferred to be the CF interface, and the wireless modules 16,17 are preferred to be the blue-tooth modules.

FIG. 2 shows the block diagram of the storage medium adapting interface device 12, which includes a buffer 121, a microprocessor 122 and a protocol command switch 123. The storage medium adapting interface device 12 is connected to the application device 11 and the electronic device 13 via the connecting interface 15 and the wireless module 16, respectively, and the protocol command switch 123 is used to convert the instruction between the connecting interface 15 and the wireless module 16. In this embodiment, the wireless module 16 of the storage medium adapting interface device 12 is a Bluetooth module, which can establish a connection with the Bluetooth module of the electronic device 13 via a wireless channel. FIG. 3 shows the message flow for establishing such a wireless connection. At first, the Bluetooth module 16 of the storage medium adapting interface device 12 sends an Inquiry command for searching the adjacent Bluetooth module. If the Bluetooth module 17 of the adjacent electronic device 13 detects this command, it replies an Inquiry Result event command to the Bluetooth module 16 of the storage medium adapting interface device 12. Then, the storage medium adapting interface device 12 sends a Create Connect command to the electronic device 13. When completing the establishment of the wireless connection, the electronic device 13 replies an Authentication Complete event command to the storage medium adapting interface device 12. Accordingly, the wireless connection between the storage medium adapting interface device 12 and the electronic device 13 is implemented.

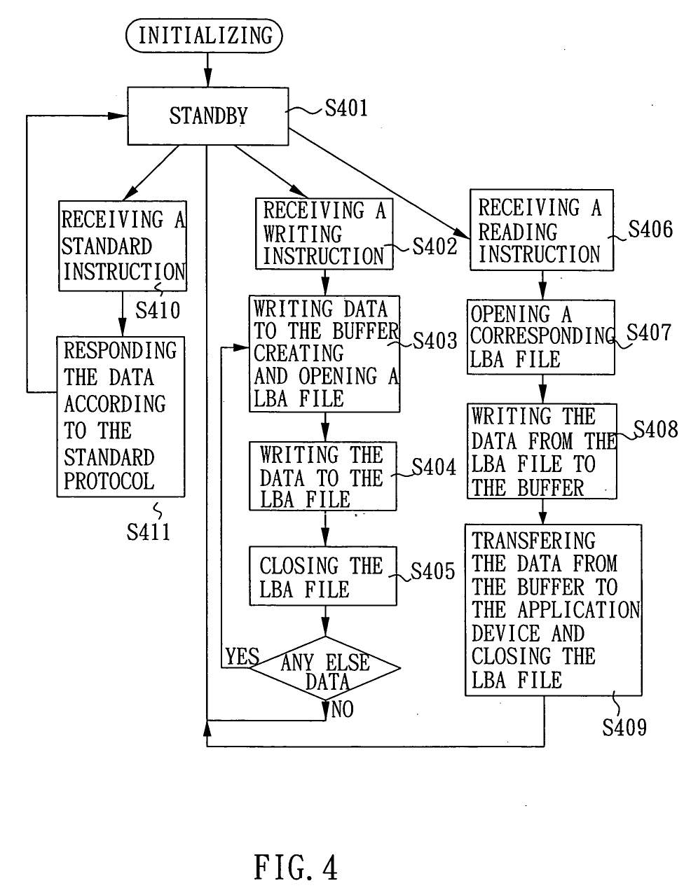

FIG. 4 is the control flow chart of the storage medium adapting interface device 12. Also with reference to FIGS. 1 and 2, when the storage medium adapting interface device 12 is inserted into the application device 11 via the interface slot 14 and the power is turned on, the storage medium adapting interface device 12 will be initialized, by which the storage medium adapting interface device 12 will be in a standby mode (step S401) after establishing a wireless connection to the adjacent electronic device 13. While the application device 11 asks for writing data (step S402) to a memory card, the microprocessor 122 interprets the LBA (Logical Block Addressing) and the quantity in the instruction, and then starts to temporarily store data into the buffer 121 accordingly. The protocol command switch 123 switches the format of the CF instruction into the Bluetooth's format, and creates and opens a LBA file in the storage device (such as hard disk) of the electronic device 13 (step S403), so that the data can be written into the storage device via the established wireless connection (step S404). Then, the LBA file will be closed (step S405). The above steps are repeated until all data has been written, thereby completing the writing operation using the storage device of the electronic device 13 to simulate the memory card.

When the application device 11 asks for reading data from the memory card (S406), the microprocessor 122 interprets the LBA and the quantity in the instruction. Then, the protocol command switch 123 switches the format of CF instruction into Bluetooth's format, and opens the corresponding LBA file in the storage device of the electronic device 13 (step S407). Therefore, the data of the LBA file can be read and written into the buffer 121 via the established wireless connection (step S408). Finally, the data stored in the buffer 121 is transferred to the application device 11 via the CF interface, and then the LBA file is closed (step S409). Accordingly, the reading operation using the storage device of the electronic device 13 to simulate the memory card is achieved.

While the application device 11 sends a standard instruction instead of the reading or writing instruction (step S410), the microprocessor 122 responds data to the application device 11 according to the standard protocol (step S411). For example, when receiving the standard Identify drive command, the microprocessor 122 responds the related data and parameters previously confirmed and stored to the application device.

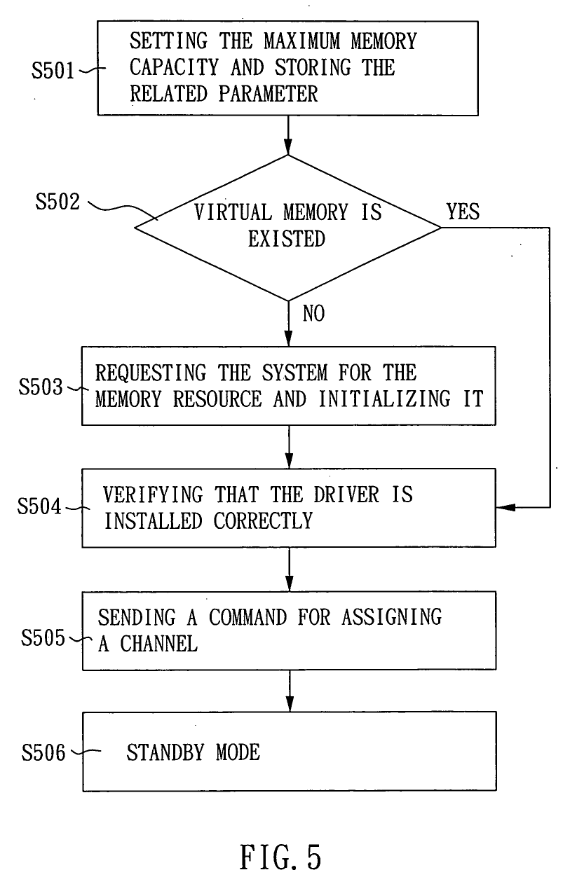

As mentioned above, in order to provide a large amount of memory space to the application device 11, the electronic device 13 has to execute an application program to suitable set and manage its memory. FIG. 5 shows an exemplary flow chart of the application program. At first, an initialization process is performed to set the maximum memory capacity and store related parameters for being used (step S501). Then, it is determined whether the virtual memory structure is existed (step S502). If there is no virtual memory structure, the process requests the system for the memory resource and initializes the requested memory (step S503). Furthermore, the driver is verified to be installed correctly (step S504) and then a command for assigning a channel is issued to the storage medium adapting interface device 12 (step S505), so as to open the channel the two devices. Finally, the application program turns into a standby mode (step S506).

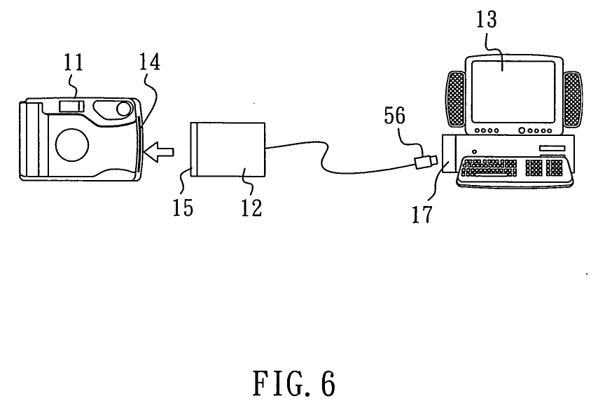

FIG. 6 is the schematic diagram of the storage medium adapting interface device 12 in accordance with a second preferred embodiment of the present invention, which is similar to the previous embodiment except that the storage medium adapting interface device 12 is connected to the electronic device 13 via a connecting interface 56 instead of the wireless module. This connecting interface 56 is preferred to be an USB interface. Therefore, the storage medium adapting interface device 12 and the electronic device 13 are connected via an USB connection. The protocol command switch (not shown) converts the commands between the two connecting interfaces 15 and 56. The other components and the operating manner of the storage medium adapting interface device 12 in this embodiment are equivalent to the previous embodiment, and thus a detailed description is deemed unnecessary.

In view of the foregoing, it is known that the storage medium adapting interface device 12 in accordance with the present invention can be connected to the storage device of the electronic device via wired or wireless connection to simulate the memory space of a memory card. Because of the large memory capacity of the storage device of the electronic device, the capacity limitation problem of the memory card is eliminated. Furthermore, when the storage medium adapting interface device 12 is inserted into a digital camera to simulate a standard memory card for storing data via the storage medium adapting interface device 12, the digital camera is operated as a standard memory card is inserted therein, and thus the design of digital camera is not affected.

Although the present invention has been explained in relation to its preferred embodiment, it is to be understood that many other possible modifications and variations can be made without departing from the spirit and scope of the invention as hereinafter claimed.

1. A storage medium adapting interface device, comprising:
a connecting interface adapted to connect to an application device and receive a command from the application device;
a wireless module adapted to connect to an electronic device having a storage device in a wireless manner;
a buffer to temporarily store data from the connecting interface and the wireless module;
a protocol command switch used to convert the commands between the connecting interface and the wireless module; and
a microprocessor to interpret the command sent from the application device via the connecting interface, wherein
when the microprocessor receives a writing command from the application device to write data to a memory card, the data is temporarily written into the buffer for storage, and the protocol command switch converts format of the writing command of the connecting interface into format of the command of the wireless module and creates and opens a file in the storage device of the electronic device, so that the data can be written into the file via the wireless connection; and when the microprocessor receives a reading command from the application device to read data from the memory card, the protocol command switch converts format of the reading command of the connecting interface into format of the command of the wireless module, and opens the file in the storage device, so that the data can be read from the file and written to the buffer via the wireless connection for being further transferred to the application device via the connecting interface.

2. The storage medium adapting interface device as claimed in claim 1, wherein when receiving a standard command instead of the reading or writing command from the application device, the microprocessor responds the data to the application device according to a standard protocol.

3. The storage medium adapting interface device as claimed in claim 1, wherein the connecting interface is a CF interface.

4. The storage medium adapting interface device as Claimed in claim 1, wherein the wireless module is a Bluetooth module.

5. A storage medium adapting interface device, comprising:
a first connecting interface adapted to connect to an application device and receive a command from the application device;
a second connecting interface adapted to connect to an electronic device having a storage device;
a buffer to temporarily store the data from the first and the second connecting interfaces;
a protocol command switch to convert commands between the first and the second connecting interfaces; and
a microprocessor to interpret the command sent from the application device via the first connecting interface, wherein
when the microprocessor receives a writing command from the application device to write data to a memory card, the data is written into the buffer to be temporarily stored, and the protocol command switch converts format of the writing command of the first connecting interface into format of the command of the second connecting interface, and creates and opens a file in the storage device of the electronic device, so that the data can be written into the file via the second connecting interface; and
when the microprocessor receives a reading command from the application device to read data from a memory card, the protocol command switch converts format of the reading command of the first connecting interface into format of the command of the second connecting interface, and opens a file in the storage device, so that the data can be read from the file and written to the buffer via the second connecting interface for being further transferred to the application device via the first connecting interface.

6. The storage medium adapting interface device as claimed in claim 5, wherein when receiving a standard command instead of the reading or a writing command, the microprocessor responds the data to the application device according to a standard protocol.

7. The storage medium adapting interface device as claimed in claim 5, wherein the first connecting interface is a CF interface.

8. The storage medium adapting interface device as claimed in claim 5, wherein the second connecting interface is an USB interface.
